(19) United States
(12) Patent Application Publication
(10) Pub. No.: US 2013/0313391 A1
(43) Pub. Date: Nov. 28, 2013

(54) SECURING PLATE AND AIRCRAFT STRUCTURE

(71) Applicant: AIRBUS OPERATIONS LIMITED, Bristol (GB)

(72) Inventor: Christopher FONSEKA, Bristol (GB)

(21) Appl. No.: 13/902,036

(22) Filed: May 24, 2013

(30) Foreign Application Priority Data
May 28, 2012 (GB) GB1209437.7

(51) Int. Cl. B64C 1/06

(52) U.S. Cl. CPC B64C 1/064
USPC 248/228.1

(57) ABSTRACT

A securing plate for clamping an end of a stringer to a surface of an aircraft structure, wherein the plate is metallic and comprises a first recess. The first recess is formed partially through the thickness of the plate. The first recess is configured so that the thickness of the plate incrementally reduces towards an end of the plate by a plurality of plate steps. Also, an aircraft structure comprising a skin having an inner surface, and a stringer extending in a longitudinal direction of the aircraft structure. The stringer comprises a stringer loot bonded to the skin inner surface and a web extending from the stringer foot and away from the skin inner surface. The aircraft structure further comprises a metallic securing plate overlying a portion of the stringer foot at an end of the stringer and which is attached to the skin.

The present invention relates to an aircraft structure and, more particularly, to an aircraft structure having a reinforcing stringer and a securing plate for use herewith.

An aircraft structure, such as a wing or fuselage, usually comprises a lightweight frame covered in a skin. The skin is reinforced by elongate strengthening elements known as stringers. The stringers are attached to the inside of the skin and provide support to the aircraft structure, especially critical during takeoff, flight, and landing, instances when the aircraft structure may be subjected to particularly high loads.

In large aircraft wing structures, such as those associated with the large aircraft commonly used for passenger and freight flight, a large number of stringers are required to maintain the shape and structural integrity of the aircraft structure. It is therefore desirable to minimise the mass of the stringers so that the performance of the aircraft is optimised and the efficiency of the aircraft is improved. However, it is important that the materials used in the manufacture of the stringers are strong, stiff and able to withstand high load conditions to provide the required level of structural reinforcement.

It is known from the prior art to construct the stringers from composite materials, such as carbon fibre, which have a high strength and stiffness but are also lightweight. However, a common problem with composite materials is that their peel strength is weak. Furthermore, there is a large shear loading action present at the stringer ‘run-out’, where the stringer terminates, particularly during aircraft ascent and descent, and during turbulence, when the wings tend to flex the most. This shear loading action is the critical design sizing condition for the stringer ‘run-out’. These peel and shear loading actions can result in disbonding, and subsequent separation, of the stringer from the aircraft skin, ultimately compromising the structural integrity of the aircraft structure.

The present invention seeks to provide an aircraft structure comprising one or more stringers configured to substantially alleviate or overcome the problems mentioned above, and a securing plate for use with such an aircraft structure.

Accordingly, the present invention provides a securing plate for clamping an end of a stringer to a surface of an aircraft structure, wherein the plate is metallic and comprises a first recess formed partially through the thickness of the plate and configured so that the thickness of the plate incrementally reduces towards an end of the plate by a plurality of plate steps.

Preferably, the securing plate comprises an upper surface and a lower surface, wherein the first recess is formed in the lower surface of the plate. The first recess may be formed in the entire lower surface of the plate.

In one preferred embodiment, the securing plate comprises a second recess that is formed into the upper surface of the plate.

Preferably, the securing plate comprises a slot formed through the thickness of the plate at an end thereof. The slot may be located centrally into said edge of the plate.

The plate may be integrally machined and the plurality of plate steps may be formed by milling.

The present invention also provides an aircraft structure comprising a skin having an inner surface, and a stringer extending in a longitudinal direction of the aircraft structure, the stringer comprising a stringer foot bonded to the skin inner surface and a web extending from the stringer foot and away from the skin inner surface, wherein the aircraft structure further comprises a metallic securing plate overlying a portion of the stringer foot at an end of the stringer and which is attached to the skin.

Preferably, the aircraft structure comprises a securing plate including any of the above-described features.

In a preferred embodiment, the securing plate is attached to the stringer foot. The securing plate may overlie the stringer foot and the skin inner surface that is adjacent to the stringer foot and the securing plate may he positioned so that a portion of the stringer foot is positioned in the first recess.

In a preferred embodiment, the stringer foot comprises a plurality of laminated plys of composite material. The thickness of the stringer foot may decrease towards an end of the stringer foot by incremental reduction in the number of plys, forming a plurality of stringer ply steps. Preferably, the plurality of ply steps are configured to correspond to the plurality of plate steps of the securing plate so as to interface with the plurality of plate steps when the securing plate is positioned on the stringer foot.

Preferably, the securing plate is mechanically secured to the stringer foot and/or skin inner surface. An interfay material may be disposed between the securing plate and the stringer foot and/or the skin inner surface.

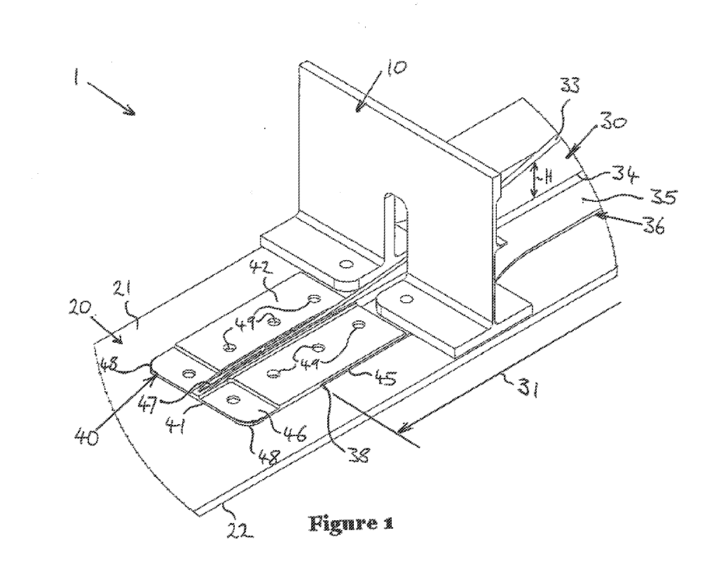

The above, as well as other aspects, objects, features and advantages of the present invention, will be better understood through the following illustrative and non-limiting detailed description, with reference to FIGS. 1-5 of the appended schematic drawings showing currently preferred embodiments of the invention, in which:

FIG. 1 shows a perspective view of a stringer run-out and securing plate of the invention on a portion of an aircraft skin;

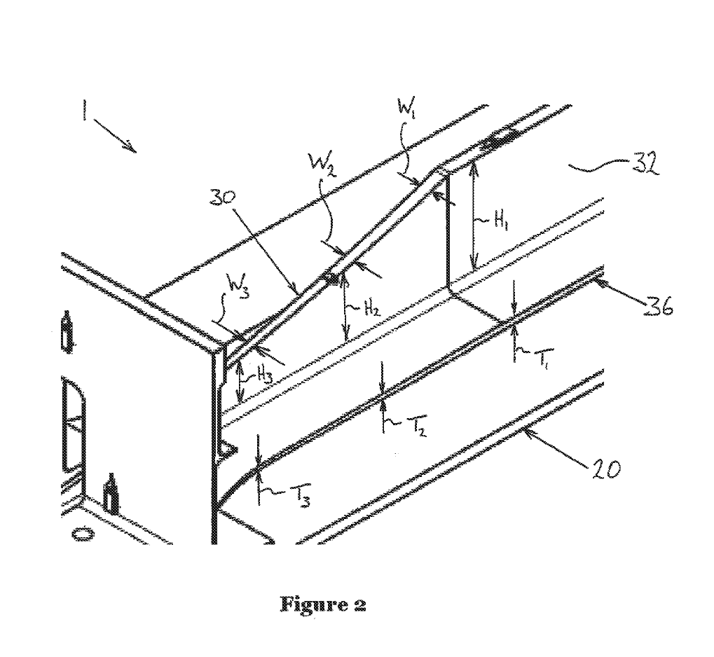

FIG. 2 shows an enlarged view of a portion of the stringer run-out of FIG. 1;

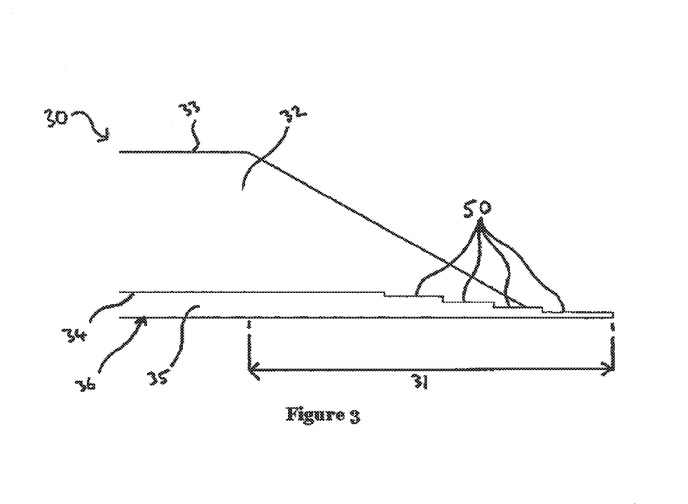

FIG. 3 shows a side view of a portion of the stringer run-out of FIG. 1;

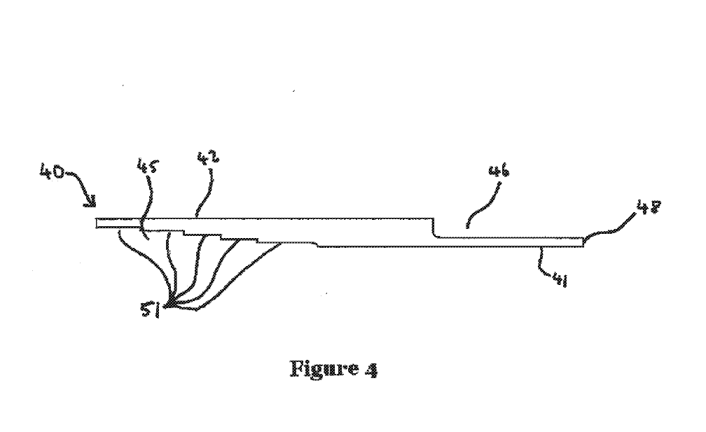

FIG. 4 shows a side view of the securing plate of FIGS. 1-2; and

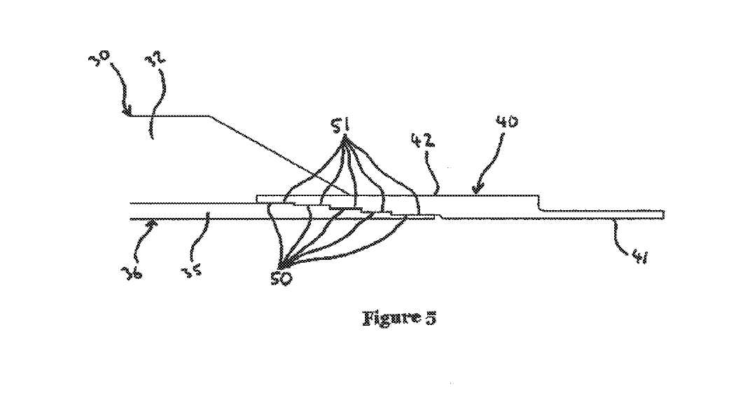

FIG. 5 shows a side view of the securing plate of FIG. 4, in position on a portion of the stringer run-out.

FIGS. 1 and 2 show perspective views of a portion of an aircraft structure 1, for example, an aircraft wing or fuselage, and comprises a frame 10 across which is provided an aircraft skin 20, The aircraft skirt 20 forms the outer shell of the aircraft structure 1, and comprises a skin inner surface 21 and a skin outer surface 22. The skin inner surface 21 is known within the aircraft industry as the inner Mould Line or ‘IML’, although will be referred to hereafter as the skin inner surface 21. A stringer 30 is bonded to the skin inner surface 21 to provide increased strength and stiffness to the aircraft structure 1 and comprises art elongate member that extends in the longitudinal direction of the aircraft structure 1. The stringer 30 comprises a web 32 having a top edge 33 and a bottom edge 34, and a flange 35 extending generally perpendicularly from the bottom edge 34 at each side of the web 32 along the length thereof, so that the cross-sectional profile of the stringer 30 is an inverted ‘T’ shape. The stringer 30 is manufactured from two ‘L’ shaped sections of composite material that are glued back-to-back to form the inverted ‘T’ shape. The composite material, such as carbon fibre, is formed from a plurality of layers of interwoven fibres, also known as ‘plys’. The flanges 35 on each side of the web 32 together form the stringer foot 36 which is bonded to the skin inner surface 21.

A stringer “run-out” portion 31 is formed at one distal end 38 of the stringer 30 and is configured to diffuse out the loads at the stringer run-out 31 and avoid localised stress concentrations on the skin 20. At the stringer run-out 31, the height of the web 32, defined as the distance between the top and bottom web edges 33, 34, is tapered towards the first distal end 38. This is shown in FIG. 2 by increasingly smaller dimensions H₁, H₂ and H₃. Also at the stringer run-out 31, the thickness W of the web 32, defined as the distance between opposite vertical sides of the web 32 in a direction generally perpendicular to the web height H, is tapered towards the first distal end 38. This reducing thickness W of the web 32 is shown in FIG. 2 by increasingly smaller dimensions W₁, W₂, and W₃.

In addition to the above, the thickness T of the stringer foot 36 is also tapered towards the first distal end 38, at the stringer run-out 31, to comprise a tapered stringer foot section. This reducing thickness T of the stringer foot 36 is shown in FIG. 2 by increasingly smaller dimensions T₁, T₂, and T₃.

The tapering of the thickness W of the web 32 and the tapering of the thickness T of the stringer foot 36 at the stringer run-out 31 is achieved by an incremental reduction in the number of laminate plys that comprise the stringer 30, forming a plurality of ply steps 50 as shown in FIG. 3, therefore, reducing the stiffness of the stringer 30 at the stringer run-out 31. Reducing the stringer 30 stiffness helps to ensure that the load in the stringer 30 is diffused out along the respective portion of the aircraft structure skin 20 at the stringer run-out 31 so that the risk of damage to the aircraft structure 1 is minimised. The gradual decrease in the structural stiffness of the stringer prevents localised stress concentrations and facilitates the gradual load transfer from skin 20 to stringer 30 at the runout 31, reducing the amount of disbonding that occurs and propagates through the structure.

A securing plate or “finger plate” 40 according to a first embodiment of the invention is provided at the stringer run-out 31 and overlies the distal end 38 of the stringer foot 36 and the aircraft skin 20 to clamp the stringer foot 36 to the skin 20 and thereby prevent peeling of the skin 20 at the stringer run-out 31. The finger plate 40 is shown in more detail in FIG. 4 and is rectangular in shape, with rounded corners 48, when viewed from above. The finger plate comprises a lower surface 41 and an upper surface 42. A first recess 45 is formed partially through the thickness of the finger plate 40 in the lower surface 41 at one end of the plate 40 and is configured so that the thickness of the finger plate 40 decreases incrementally towards said end by a plurality of plate steps 51, as shown in FIG. 4. The finger plate 40 is metallic, and, therefore, may be manufactured by being integrally machined from a single piece of metal and the plurality of steps 51 may be formed by milling the first recess 45 into the lower surface 41 of the finger plate 40, allowing for accurate and high throughput manufacture. The depth of the first recess 45 corresponds to the thickness of the stringer foot 36 at the end of the stringer run-out 31, and the plurality of steps 51 are configured to interface with corresponding ply steps 50 of the stringer run-out to allow for the finger plate 40 to be positioned so that the end of the stringer foot 36 is located in the first recess 45, as shown in FIG. 5.

A central slot 47 is formed through the thickness of the finger plate 40 from the edge thereof that the first recess 45 is formed in. The end of the web 32 is slotted in the slot 47 to prevent lateral displacement of the stringer 30.

A second recess 46 is formed partially through the thickness of the finger plate 40 in the upper surface 42 at the end thereof that is remote to the first recess 45. This reduces the weight of the finger plate 40 but is not essential to the function of the invention.

Bolt holes 49 are included in the finger plate 40, allowing the finger plate 40 to be mechanically secured, by bolts, to the stringer foot 36 and aircraft skin 20. The fit of the bolts or other mechanical fasteners can be “clearance” fit or “interference” fit. This means for the latter the fastener diameter is slightly larger than the hole it is installed in. For the former, it means that the fastener diameter is slightly smaller than the hole it is installed in. Such mechanical fasteners are not limited to bolts within the scope of the invention and include any other mechanical fasteners, such as, for example, rivets.

An interfay material, such as a ‘liquid shim’, may also be provided between the finger plate 40 and the end portion of the stringer foot 36, and/or between these portions and the skin 20, to provide a good fit therebetween with no gaps and to prevent ingress of air or moisture.

The finger plate 40 clamps the stringer run-out 31 to the aircraft skin 20, preventing disbonding of the stringer 30 from the inner surface 21 of the aircraft skin 20 when the stringer 30 is subjected to peeling loads. Since such disbonding in conventional aircraft structures initiates at the distal ends of the stringers, this configuration prevents the onset and propagation of stringer separation. Furthermore, the finger plate 40 provides an additional load path that helps to evenly spread the load transferred from the stringer 30 to the aircraft skin 20 at the stringer run-out 31.

The stringer run-out 31 ply steps 50 fit snugly against the finger plate steps 51 so that a large surface area of the lower surface 41 of the finger plate 40 is in contact with the upper surface area of the stringer run-out 31, to further improve the clamping of the stringer 30 to the aircraft skin 20 and the uniformity of the load transfer compared to a conventional non-stepped, flat-bottomed, finger plate, which would only exert a clamping force on the edge of each step 50, rather than the whole upper surface of each ply of the end of the stringer run-out 31.

Although in the above-described embodiment the finger plate 40 has rounded. corners 48, in alternative embodiments the corners 48 may be chamfered or square.

Although in the above-described embodiment the stringer foot 36 extends to the distal end of the web 32, in alternate embodiments (not shown) the stringer foot 36 may extend past the distal end of the web 32 so that the distal end of the stringer 30 is flat, which can aid attachment to the skin inner surface 21 and/or the finger plate 40.

Although in the above-described embodiment the first recess 45 is formed in an end of the finger plate 40, in an alternate embodiment (not shown) the first recess 45 may be formed remote from the ends of the finger plate 40. In a further embodiment (not shown) the first recess is formed into the entire lower surface of the plate.

Although in the above-described embodiment the finger plate 40 abuts the aircraft skin 20, in an alternate embodiment (not shown) the finger plate 40 may not overlie the end of the stringer run-out 31 and so does not abut the aircraft skin.

Although in the above-described embodiment the second recess 46 is formed in an end of the finger plate 40, in an alternate embodiment (not shown) the second recess may be formed remote from the ends of the finger plate. In vet another embodiment (not shown) the second recess may be omitted entirely.

Although in the above-described embodiment the slot 47 is positioned centrally in the finger plate 40, in an alternate embodiment (not shown) the first slot may be positioned in a non-central position. In yet a further embodiment (not shown) the slot may be omitted entirely.

It will be appreciated that the term “comprising” does not exclude other elements or steps and that the indefinite article “a” or “an” does not exclude a plurality, Although claims have been formulated in this application to particular combinations of features, it should he understood that the scope of the invention is intended to include any combination of non-mutually exclusive features described above.

1. A securing plate for clamping an end of a stringer to a surface of an aircraft structure, wherein the plate is metallic and comprises a first recess formed partially through the thickness of the plate and configured so that the thickness of the plate incrementally reduces towards an end of the plate by a plurality of plate steps.

2. A securing plate according to claim 1 comprising an upper surface and a lower surface, wherein the first recess is formed in the lower surface of the plate.

3. A securing plate according to claim 2 wherein the first recess is formed in the entire lower surface of the plate.

4. A securing plate according to claim 2 comprising a second recess that is formed into the upper surface of the plate.

5. A securing plate according to claim 1 comprising a slot formed through the thickness of the plate at an end thereof.

6. A securing plate according to claim 5 wherein the slot is located centrally into said edge of the plate.

7. A securing plate according to claim 1 wherein the plate is integrally machined.

8. A securing plate according to claim 1 wherein the plurality of plate steps are formed by milling.

9. An aircraft structure comprising a skin having an inner surface, and a stringer extending in a longitudinal direction of the aircraft structure, the stringer comprising a stringer foot bonded to the skin inner surface and a web extending from the stringer foot and away from the skin inner surface, wherein the aircraft structure further comprises a metallic securing plate overlying a portion of the stringer foot at an end of the stringer and which is attached to the skin.

10. An aircraft structure according to claim 9 wherein the securing plate is configured for clamping an end of a stringer to a surface of an aircraft structure, wherein the plate is metallic and comprises a first recess formed partially through the thickness of the plate and configured so that the thickness of the plate incrementally reduces towards an end of the plate by an plurality of plate steps.

11. An aircraft structure according to claim 9 wherein the securing plate is attached to the stringer foot.

12. An aircraft structure according to claim 9, wherein the securing plate overlies the stringer foot and the skin inner surface that is adjacent to the stringer foot.

13. An aircraft structure according to claim 10, wherein the securing plate is positioned so that a portion of the stringer foot is positioned in the first recess.

14. An aircraft structure according to claim 9, wherein the stringer foot comprises a plurality of laminated plys of composite material.

15. An aircraft structure according to claim 14 wherein the thickness of the stringer foot decreases towards an end of the stringer foot by incremental reduction in the number of plys, forming a plurality of stringer ply steps.

16. An aircraft structure according to claim 15, configured so that the plurality of ply steps are configured to correspond to the plurality of plate steps of the securing plate so as to interface with the plurality of plate steps when the securing plate is positioned on the stringer foot.

17. An aircraft structure according to claim 9, wherein the securing plate is mechanically secured to the stringer foot and/or skin inner surface.

18. An aircraft structure according to claim 9 wherein an interfay material is disposed between the securing plate and the stringer foot and/or the skin inner surface.
